(19) United States
(12) Patent Application Publication
(10) Pub. No.: US 2015/0277011 A1
(43) Pub. Date: Oct. 1, 2015

(54) OPTICAL MEMBER, POLARIZING PLATE SET, AND LIQUID CRYSTAL DISPLAY APPARATUS

(71) Applicant: NITTO DENKO CORPORATION, Osaka (JP)

(72) Inventors: Kozo Nakamura, Ibaraki-shi (JP); Kazuki Uwada, Ibaraki-shi (JP); Hiromoto Haruta, Ibaraki-shi (JP); Takehito Fuchida, Ibaraki-shi (JP); Hiroyuki Takemoto, Ibaraki-shi (JP); Nao Murakami, Ibaraki-shi (JP); Daisuke Hattori, Ibaraki-shi (JP)

(73) Assignee: NITTO DENKO CORPORATION, Osaka (JP)

(21) Appl. No.: 14/670,751

(22) Filed: Mar. 27, 2015

(30) Foreign Application Priority Data
Mar. 31, 2014 (JP) 2014-073755
Jan. 13, 2015 (JP) 2015-004045

(51) Int. Cl. G02B 5/30; G02B 5/04; G02F 1/1335

(52) U.S. Cl. CPC G02B 5/3083; G02F 1/133528; G02B 5/045

(57) ABSTRACT

Provided is an optical member that can realize a liquid crystal display apparatus that is excellent in mechanical strength and provides sufficient brightness. The optical member includes: a polarizing plate; a low refractive index layer having a selected refractive index; and a prism sheet.

### BACKGROUND OF THE INVENTION

1. Field of the Invention

This application claims priority under 35 U.S.C. Section 119 to Japanese Patent Application No. 2014-073755 filed on Mar. 31, 2014 and Japanese Patent Application No. 2015-004045 filed on Jan. 13, 2015, which are herein incorporated by reference.

The present invention relates to an optical member, a polarizing plate set, and a liquid crystal display apparatus. More specifically, the present invention relates to an optical member including a polarizing plate, a low refractive index layer having a selected refractive index, and a prism sheet, and a polarizing plate set and a liquid crystal display apparatus each using the optical member.

2. Description of the Related Art

In recent years, as a display, a liquid crystal display apparatus using a surface light source device has been remarkably widespread. Ina liquid crystal display apparatus including an edge light-type surface light source device, for example, light emitted from a light source enters a light guide plate, and propagates through an inside of the light guide plate while repeating a total reflection on a light output surface (liquid crystal cell-side surface) of the light guide plate and a back surface thereof. A part of the light that propagates through the inside of the light guide plate allows a traveling direction thereof to be changed by a light scattering body or the like, which is provided on the back surface of the light guide plate or the like, and is output from the light output surface to an outside of the light guide plate. Such light output from the light output surface of the light guide plate is diffused and condensed by various optical sheets such as a diffusion sheet, a prism sheet, a brightness enhancement film, or the like, and thereafter, the light enters a liquid crystal display panel in which polarizing plates are arranged on both sides of a liquid crystal cell. Liquid crystal molecules of a liquid crystal layer of the liquid crystal cell are driven for each of pixels to control transmission and absorption of the incident light. As a result, an image is displayed.

Typically, the above-mentioned prism sheet is fitted into a casing of the surface light source device, and is provided close to the light output surface of the light guide plate. In a liquid crystal display apparatus using such a surface light source device as described above, the prism sheet and the light guide plate are rubbed against each other when installing the prism sheet or under an actual usage environment, and the light guide plate is flawed in some cases. In order to solve such a problem, a technology for integrating the prism sheet with a light source-side polarizing plate is proposed (see Japanese Patent Application Laid-open No. H11-295714 A). However, a liquid crystal display apparatus using such polarizing plate with which the prism sheet is integrated involves a problem in that sufficient brightness is not obtained.

### SUMMARY OF THE INVENTION

The present invention has been made to solve the above-mentioned problems of the related art, and an object of the present invention is to provide an optical member that can realize a liquid crystal display apparatus that is excellent in mechanical strength and provides sufficient brightness.

An optical member according to an embodiment of the present invention comprises a polarizing plate, a low refractive index layer, and a prism sheet. A refractive index n of the low refractive index layer satisfies a relationship of 1<n≦1.25.

In one embodiment of the invention, the refractive index n of the low refractive index layer and a thickness d (nm) thereof satisfy a relationship represented by one of the following formulae (1) and (2).

1<n≦1.20 and 300≦d (1)

1.20<n≦1.25 and 500≦d (2)

In one embodiment of the invention, the prism sheet comprises an array of a plurality of columnar unit prisms that are convex toward a side opposite to the low refractive index layer.

In one embodiment of the invention, the polarizing plate and the low refractive index layer are directly laminated through a pressure-sensitive adhesive.

In one embodiment of the invention, the optical member comprises the polarizing plate, the low refractive index layer, and the prism sheet in the stated order.

According to another aspect of the present invention, there is provided a polarizing plate set. The polarizing plate set comprises the above-described optical member to be used as a back surface-side polarizing plate; and a viewer-side polarizing plate.

According to another aspect of the present invention, there is provided a liquid crystal display apparatus. The liquid crystal display apparatus comprises a liquid crystal cell; a polarizing plate arranged on a viewer side of the liquid crystal cell; and the above-described optical member arranged on a side of the liquid crystal cell opposite to the viewer side.

### BRIEF DESCRIPTION OF THE DRAWINGS

FIG. 1 is a schematic sectional view illustrating an optical member according to one embodiment of the present invention.

FIG. 2 is an exploded perspective view of the optical member of FIG. 1.

FIG. 3 is a schematic sectional view illustrating a liquid crystal display apparatus according to one embodiment of the present invention.

FIG. 4A is a schematic sectional view illustrating the aligned state of a liquid crystal molecule in a VA mode.

FIG. 4B is a schematic sectional view illustrating the aligned state of a liquid crystal molecule in a VA mode.

### DETAILED DESCRIPTION OF THE PREFERRED EMBODIMENTS

Hereinafter, embodiments of the present invention are described with reference to the drawings. However, the present invention is not limited to these embodiments.

A. Entire Construction of Optical Member

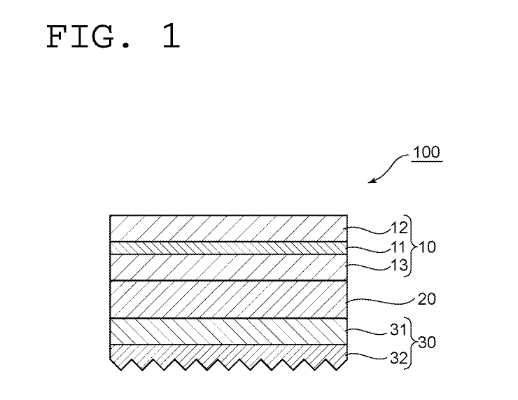

FIG. 1 is a schematic sectional view illustrating an optical member according to one embodiment of the present invention. An optical member 100 includes a polarizing plate 10, a low refractive index layer 20, and a prism sheet 30. The polarizing plate 10 and the low refractive index layer 20 are typically directly laminated through a pressure-sensitive adhesive. The optical member 100 typically includes the polarizing plate 10, the low refractive index layer 20, and the prism sheet 30 in the stated order. The polarizing plate 10 typically includes a polarizer 11, a protective layer 12 arranged on one side of the polarizer 11, and a protective layer 13 arranged on the other side of the polarizer 11. The prism sheet 30 typically includes a base portion 31 and a prism portion 32. The polarizing plate and the prism sheet are integrated as described above, and hence an air layer between the prism sheet and the polarizing plate can be eliminated, which can contribute to the thinning of a liquid crystal display apparatus. The thinning of the liquid crystal display apparatus has a high commercial value because the thinning widens the selection of design. Further, eliminating the air layer can suppress undesired reflection and refraction at an interface between the air layer and the prism sheet and/or the polarizing plate, and hence can prevent adverse effects on the display characteristics of the liquid crystal display apparatus. In addition, integrating the polarizing plate and the prism sheet enables the avoidance of a flaw in the prism sheet due to rubbing upon attachment of the prism sheet to a surface light source device (a backlight unit or substantially a light guide plate), and hence can prevent the turbidity of display resulting from such flaw and can provide a liquid crystal display apparatus excellent in mechanical strength.

A refractive index n of the low refractive index layer satisfies a relationship of 1<n≦1.25. The refractive index n is preferably 1.20 or less. In the present invention, arranging the low refractive index layer having such refractive index between the polarizing plate and the prism sheet can provide additionally high brightness in the liquid crystal display apparatus. This is because of the following reason: the angle at which total reflection occurs varies depending on the refractive index of the low refractive index layer, and as the refractive index n reduces, the efficiency of reflection by the low refractive index layer improves. As a result, arranging the low refractive index layer as described above increases the reflectance of incident light tilted toward a polar angle direction and hence can provide additionally high brightness in the liquid crystal display apparatus.

In one embodiment, the refractive index n of the low refractive index layer and a thickness d (nm) thereof satisfy a relationship represented by one of the following formulae (1) and (2).

1<n≦1.20 and 300≦d (1)

1.20<n≦1.25 and 500≦d (2)

The presence of the above-mentioned construction increases the reflectance of the incident light tilted toward the polar angle direction and hence can provide additionally high brightness in the liquid crystal display apparatus. That is, in the case where a value for the refractive index n is small, sufficient reflection efficiency can be obtained in the low refractive index layer even when its thickness d is small. This is because the efficiency of the reflection by the low refractive index layer improves as the thickness d of the low refractive index layer increases.

Any appropriate value can be adopted as the thickness d of the low refractive index layer as long as the value can satisfy the relationship represented by the formula (1) or (2). When the refractive index n of the low refractive index layer satisfies a relationship of 1<n≦1.20, the thickness d is, for example, 400 nm or more, preferably 500 nm or more, more preferably 600 nm or more. When the refractive index n satisfies a relationship of 1.20<n≦1.25, the thickness d is, for example, 600 nm or more, preferably 700 nm or more, more preferably 800 nm or more. When the thickness d of the low refractive index layer falls within the range, the reflectance of the incident light tilted toward the polar angle direction by the low refractive index layer additionally increases. As a result, additionally high brightness can be obtained in the liquid crystal display apparatus.

One embodiment of the present invention has been made to solve the following newly found problem: in a liquid crystal display apparatus using an optical member obtained by integrating a polarizing plate and a prism sheet, sufficient brightness is not obtained as compared with a liquid crystal display apparatus using an optical member in which the polarizing plate and the prism sheet are separately arranged. As described above, arranging the low refractive index layer having a selected refractive index between the polarizing plate and the prism sheet can suppress a reduction in brightness of the liquid crystal display apparatus as a problem peculiar to the polarizing plate integrated with the prism sheet. The technical meaning of the arrangement of the low refractive index layer between the polarizing plate and the prism sheet is as described below. In a related-art construction in which the polarizing plate and the prism sheet are used while being separately arranged, the refraction of light occurs in accordance with Snell's law and hence only light having an angle of less than about 40° enters the polarizing plate. However, in a construction free of any air interface by virtue of the integration of the polarizing plate and the prism sheet, light bent by the prism sheet advances in various angles ranging from front to oblique directions because total reflection by the air interface does not occur. That is, when the angle at which light vertically enters a surface is defined as 0°, light tilted toward the polar angle direction by 40° or more (e.g., 40° to 50°) enters the polarizing plate. Therefore, in the case where the integrated optical member is used as a back surface-side polarizing plate for the liquid crystal display apparatus, when the light tilted toward the polar angle direction enters the polarizing plate, the light is absorbed and attenuated by the polarizing plate, and is totally reflected at an interface between an upper plate and air to return to the back surface side. As a result, most of the light cannot be output toward a viewer side. Therefore, the quantity of the light to be utilized on the viewer side reduces and hence the brightness of the liquid crystal display apparatus reduces. However, when the low refractive index layer is arranged between the polarizing plate and the prism sheet, the incident light tilted toward the polar angle direction can be totally reflected by the low refractive index layer before the incidence of the light into the polarizing plate. The totally reflected light is reflected on a backlight side and can be reused on the viewer side, and as a result, high brightness can be obtained in the liquid crystal display apparatus.

Hereinafter, each constituent of the optical member is described in detail.

B. Polarizing Plate

The polarizing plate 10 typically includes the polarizer 11, the protective layer 12 arranged on one side of the polarizer 11, and the protective layer 13 arranged on the other side of the polarizer 11. The polarizer is typically an absorption-type polarizer.

B-1. Polarizer

The transmittance of the above-mentioned absorption-type polarizer (also referred to as a single axis transmittance) at the wavelength of 589 nm is preferably 41% or more, more preferably 42% or more. Note that, the theoretical upper limit of the single axis transmittance is 50%. In addition, polarization degree thereof is preferably from 99.5% to 100%, more preferably from 99.9% to 100%. As long as the single axis transmittance and the polarization degree fall within the range, contrast in the front direction can be further higher when used in the liquid crystal display apparatus.

The single axis transmittance and polarization degree described above can be measured with a spectrophotometer. A specific measurement method for the polarization degree may involve measuring parallel transmittance (H₀) and perpendicular transmittance (H₉₀)) of the polarizer, and determining the polarization degree through the following expression: polarization degree (%)={(H₀−H₉₀)/(H₀+H₉₀)}^{1/2}×100. The parallel transmittance (H₀) refers to a value of transmittance of a parallel-type laminated polarizer prepared by causing two identical polarizers to overlap with each other in such a manner that absorption axes thereof are parallel to each other. In addition, the perpendicular transmittance (H₉₀) refers to a value of a transmittance of a perpendicular-type laminated polarizer prepared by causing two identical polarizers to overlap with each other in such a manner that absorption axes thereof are perpendicular to each other. Note that, each transmittance is a Y value obtained through relative spectral responsivity correction at a two-degree field of view (C light source) in JIS Z 8701-1982.

Any appropriate polarizer may be adopted as the absorption-type polarizer depending on purpose. Examples thereof include a polarizer obtained by causing a hydrophilic polymer film such as a polyvinyl alcohol-based film, a partially formalized polyvinyl alcohol-based film, or an ethylene-vinyl acetate copolymer-based partially saponified film to absorb a dichroic substance such as iodine or a dichroic dyestuff, followed by uniaxial stretching, and a polyene-based alignment film such as a product obtained by subjecting polyvinyl alcohol to dehydration treatment or a product obtained by subjecting polyvinyl chloride to dehydrochlorination treatment. In addition, there may also be used, for example, guest-host-type E-type and O-type polarizers each including a dichroic substance and a liquid crystalline compound in which the liquid crystalline compound is aligned in a fixed direction as disclosed in, for example, U.S. Pat. No. 5,523,863, and E-type and O-type polarizers in which the lyotropic liquid crystals are aligned in a fixed direction as disclosed in, for example, U.S. Pat. No. 6,049,428.

Of such polarizers, a polarizer formed of a polyvinyl alcohol (PVA)-based film containing iodine is suitably used from the viewpoint of having a high polarization degree. The polyvinyl alcohol or a derivative thereof is used as a material for the polyvinyl alcohol-based film to be applied to the polarizer. Examples of the derivative of polyvinyl alcohol include polyvinyl formal and polyvinyl acetal as well as polyvinyl alcohol modified with, for example, an olefin such as ethylene or propylene, an unsaturated carboxylic acid such as acrylic acid, methacrylic acid, or crotonic acid, alkyl ester thereof, or acrylamide. Polyvinyl alcohol having a polymerization degree of about from 1,000 to 10,000 and a saponification degree of about from 80 mol % to 100 mol % are generally used.

The polyvinyl alcohol-based film (unstretched film) is subjected to at least uniaxial stretching treatment and iodine dyeing treatment according to conventional methods, and may further be subjected to boric acid treatment or iodine ion treatment. In addition, the polyvinyl alcohol-based film (stretched film) subjected to the treatment described above becomes a polarizer through drying according to a conventional method.

The stretching method in the uniaxial stretching treatment is not particularly limited, and any one of a wet stretching method and a dry stretching method may be adopted. As a stretching means for the dry stretching method, there is given, for example, a roll stretching method, a heating roll stretching method, or a compression stretching method. The stretching may be performed in a plurality of steps. In the stretching means, the unstretched film is generally in a heated state. A film having a thickness of about from 30 μm to 150 μm is generally used as the unstretched film. The stretching ratio of the stretched film may be appropriately set depending on purpose. However, the stretching ratio (total stretching ratio) is about from 2 times to 8 times, preferably from 3 times to 6.5 times, more preferably from 3.5 times to 6 times. The thickness of the stretched film is suitably about from 5 μm to 40 μm.

The iodine dyeing treatment is performed by immersing the polyvinyl alcohol-based film in an iodine solution containing iodine and potassium iodide. The iodine solution is generally an iodine aqueous solution, and contains iodine and potassium iodide as a dissolution aid. The concentration of iodine is preferably about from 0.01 wt % to 1 wt %, more preferably from 0.02 wt % to 0.5 wt %, and the concentration of potassium iodide is preferably about from 0.01 wt % to 10 wt %, more preferably from 0.02 wt % to 8 wt %.

In iodine dyeing treatment, the temperature of the iodine solution is generally about from 20° C. to 50° C., and is preferably from 25° C. to 40° C. Time period of the immersion falls within a range of generally about from 10 seconds to 300 seconds, and is preferably from 20 seconds to 240 seconds. In iodine dyeing treatment, through adjustment of conditions such as the concentration of the iodine solution, and the immersion temperature and time period of the immersion of polyvinyl alcohol-based film into the iodine solution, iodine content and potassium content in the polyvinyl alcohol-based film is adjusted so as to allow both to fall within a desires range. The iodine dyeing treatment may be performed at any one of the time points before the uniaxial stretching treatment, during the uniaxial stretching treatment, and after the uniaxial stretching treatment.

The boric acid treatment is performed by immersing the polyvinyl alcohol-based film in a boric acid aqueous solution. The concentration of boric acid in the boric acid aqueous solution is about from 2 wt % to 15 wt %, preferably from 3 wt % to 10 wt %. Potassium iodide, potassium ion and iodine ion may be incorporated in the boric acid aqueous solution. The concentration of potassium iodide in the boric acid aqueous solution is about from 0.5 wt % to 10 wt %, and is preferably from 1 wt % to 8 wt %. A polarizer with low coloration, that is, almost constant absorbance over approximately entire wavelength region of visible light, so-called neutral grey can be obtained with a boric acid aqueous solution containing potassium iodide.

For example, an aqueous solution obtained by incorporating iodine ion with, for example, potassium iodide is used for the iodine ion treatment. The concentration of potassium iodide is preferably about from 0.5 wt % to 10 wt %, more preferably from 1 wt % to 8 wt %. In iodine ion immersion treatment, the temperature of the aqueous solution is generally about from 15° C. to 60° C., and is preferably from 25° C. to 40° C. Time period of the immersion is generally about from 1 second to 120 seconds, and preferably falls within a range of from 3 seconds to 90 seconds. The time point of the iodine ion treatment is not particularly limited as long as the time point is before the drying step. The treatment may be performed after water washing described later.

The polyvinyl alcohol-based film (stretched film) subjected to the treatment described above may be subjected to a water washing step and a drying step according to a conventional method.

Any appropriate drying method such as natural drying, drying by blowing, or drying by heating may be adopted as the drying step. In the case of the drying by heating, for example, drying temperature thereof is typically from 20° C. to 80° C., and is preferably from 25° C. to 70° C. Time period of the drying is preferably about from 1 minute to 10 minutes. In addition, the moisture content of the polarizer after the drying is preferably from 10 wt % to 30 wt %, more preferably from 12 wt % to 28 wt %, still more preferably from 16 wt % to 25 wt %. When the moisture content is excessively high, in drying the polarizing plate, the polarization degree is liable to decrease in accordance with the drying of the polarizer. In particular, the perpendicular transmittance in a short wavelength region of 500 nm or less is increased, that is, the black display is liable to be colored with blue because of the leakage of the short wavelength light. On the contrary, when the moisture content of the polarizer is excessively small, a problem such as local uneven defect (knick defect) may easily occur.

The polarizing plate 10 is typically provided in a long shape (e.g., a roll shape) and used in the production of an optical member. In one embodiment, the polarizer has an absorption axis in its lengthwise direction. Such polarizer can be obtained by a production method that has been conventionally employed in the art (e.g., such production method as described above). In another embodiment, the polarizer has the absorption axis in its widthwise direction.

B-2. Protective Layer

The protective layer is formed of any appropriate film that may be used as a protective film for the polarizer. Specific examples of a material serving as a main component of the film include transparent resins such as a cellulose-based resin such as triacetylcellulose (TAC), a polyester-based resin, a polyvinyl alcohol-based resin, a polycarbonate-based resin, a polyamide-based resin, a polyimide-based resin, a polyether sulfone-based resin, a polysulfone-based resin, a polystyrene-based resin, a polynorbornene-based resin, a polyolefin-based resin, a (meth)acrylic resin, and an acetate-based resin. Another example thereof is a thermosetting resin or a UV-curable resin such as a (meth)acrylic resin, a urethane-based resin, a (meth)acrylic urethane-based resin, an epoxy-based resin, or a silicone-based resin. Still another example thereof is a glassy polymer such as a siloxane-based polymer. Further, a polymer film described in JP 2001-343529 A (WO 01/37007 A1) may also be used. As a material for the film, for example, there may be used a resin composition containing a thermoplastic resin having a substituted or unsubstituted imide group in a side chain and a thermoplastic resin having a substituted or unsubstituted phenyl group and a nitrile group in a side chain. An example thereof is a resin composition containing an alternate copolymer formed of isobutene and N-methylmaleimide and an acrylonitrile-styrene copolymer. The polymer film may be an extruded product of the resin composition, for example. The protective layers may be identical to or different from each other.

The thickness of each of the protective layers is preferably from 10 μm to 100 μm. Each of the protective layers may be laminated on the polarizer through an adhesion layer (specifically an adhesive layer or a pressure-sensitive adhesive layer), or may be laminated so as to be in close contact with the polarizer (without through the adhesion layer). The adhesive layer is formed of any appropriate adhesive. The adhesive is, for example, a water-soluble adhesive using a polyvinyl alcohol-based resin as a main component. The water-soluble adhesive using the polyvinyl alcohol-based resin as a main component can preferably further contain a metal compound colloid. The metal compound colloid can be such that metal compound fine particles are dispersed in a dispersion medium, and the colloid can be a colloid that electrostatically stabilizes as a result of interactive repulsion between the charges of the same kind of the fine particles to permanently have stability. The average particle diameter of the fine particles forming the metal compound colloid can be any appropriate value as long as the average particle diameter does not adversely affect the optical characteristics of the polarizer such as a polarization characteristic. The average particle diameter is preferably from 1 nm to 100 nm, more preferably from 1 nm to 50 nm. This is because the fine particles can be uniformly dispersed in the adhesive layer, its adhesion can be secured, and a knick can be suppressed. It should be noted that the term “knick” refers to a local uneven defect that occurs at an interface between the polarizer and each of the protective layers.

C. Low Refractive Index Layer

Any appropriate low refractive index layer may be adopted as the low refractive index layer 20 as long as its refractive index n satisfies a relationship of 1<n≦1.25. The thickness of the low refractive index layer is as described above.

The low refractive index layer typically has a void in itself. The void ratio of the low refractive index layer may take any appropriate value. The void ratio is, for example, from 5% to 90%, preferably from 25% to 80%. When the void ratio falls within the range, the low refractive index layer can be sufficiently reduced in refractive index and can obtain a high mechanical strength.

The low refractive index layer having a void in itself is, for example, a low refractive index layer at least partially having a porous layer and/or an air layer. The porous layer typically contains aerogel and/or particles (such as hollow fine particles and/or porous particles). The low refractive index layer is preferably a nanoporous layer (specifically a porous layer 90% or more of the fine pores of which each have a diameter in the range of from 10⁻¹ to 10³ nm).

Any appropriate material can be adopted as a material for forming the low refractive index layer. For example, materials described in International Patent WO2004/113966A, Japanese Patent Application Laid-open No. 2013-254183, and Japanese Patent Application Laid-open No. 2012-189802 may each be adopted as the material. Specific examples thereof include: silica-based compounds; hydrolyzable silanes, and partial hydrolysates and dehydration condensates thereof; organic polymers; silicon compounds each containing a silanol group; active silica obtained by bringing a silicate into contact with an acid or an ion exchange resin; polymerizable monomers (such as a (meth)acrylic monomer and a styrene-based monomer); curable resins (such as a (meth)acrylic resin, a fluorine-containing resin, and a urethane resin); and a combination thereof.

Examples of the organic polymer include polyolefins (such as polyethylene and polypropylene), polyurethanes, fluorine-containing polymers (such as a fluorine-containing copolymer having as constituents a fluorine-containing monomer unit and a constituent unit for imparting cross-linking reactivity), polyesters (such as a poly(meth)acrylic acid derivative (as used herein, the term “(meth)acrylic acid” means acrylic acid and methacrylic acid, and the expression “(meth)” has such meaning in all cases)), polyethers, polyamides, polyimides, polyureas, and polycarbonates.

The material preferably contains: a silica-based compound; a hydrolyzable silane; or a partial hydrolysate or dehydration condensate thereof.

Examples of the silica-based compound include: SiO₂ (silicic anhydride); a compound containing SiO₂ and at least one compound selected from the group consisting of Na₂O—B₂O₃ (borosilicate), Al₂O₃ (alumina), B₂O₃, TiO₂, ZrO₂, SnO₂, Ce₂O₃, P₂O₅, Sb₂O₃, MoO₃, ZnO₂, WO₃, TiO₂—Al₂O₃, TiO₂—ZrO₂, In₂O₃—SnO₂, and Sb₂O₃—SnO₂ (the character “-” indicates a complex oxide).

For example, an alkyl group-containing hydrolyzable silane that may have a substituent (such as fluorine) is given as the hydrolyzable silane. The hydrolyzable silane, and the partial hydrolysate and dehydration condensate thereof are preferably an alkoxysilane and silsesquioxane.

The alkoxysilane may be a monomer or an oligomer. The alkoxysilane monomer preferably has three or more alkoxy groups. Examples of the alkoxysilane monomer include methyltrimethoxysilane, methyltriethoxysilane, phenyltriethoxysilane, tetramethoxysilane, tetraethoxysilane, tetrabutoxysilane, tetrapropoxysilane, diethoxydimethoxysilane, dimethyldimethoxysilane, and dimethyldiethoxysilane. A polycondensate obtained by subjecting the monomer to hydrolysis and polycondensation is preferred as the alkoxysilane oligomer. The low refractive index layer having excellent uniformity is obtained through the use of the alkoxysilane as the material.

A silsesquioxane is a generic term for network polysiloxane represented by a general formula RSiO_{1.5} (where R represents an organic functional group). Examples of R include an alkyl group (that may be linear or branched and has 1 to 6 carbon atoms), a phenyl group, and an alkoxy group (such as a methoxy group or an ethoxy group). Examples of the structure of the silsesquioxane include a ladder-type structure and a cage-type structure. The use of the silsesquioxane as the material provides a low refractive index layer having excellent uniformity, excellent weatherability, excellent transparency, and an excellent hardness.

Any appropriate particles may be adopted as the particles. The particles are each typically formed of a silica-based compound.

Any appropriate shapes may be adopted as the shapes of the particles in the low refractive index layer. Examples of the shapes include a spherical shape, a plate-like shape, a needle-like shape, a string-like shape, and a grape cluster-like shape. Examples of a particle of the string-like shape include: a particle obtained by connecting a plurality of particles each having a spherical shape, a plate-like shape, or a needle-like shape in a beaded manner; a short fibrous particle (such as a short fibrous particle described in Japanese Patent Application Laid-open No. 2001-188104); and a combination thereof. The string-shaped particle may be linear or may be branched. A silica particle of the grape cluster-like shape is, for example, a particle of a grape cluster-like shape obtained by the agglomeration of a plurality of particles having spherical, plate-like, and needle-like shapes. The shapes of the silica particles may be confirmed by, for example, observation with a transmission electron microscope.

The average particle diameter of the particles is, for example, from 5 nm to 200 nm, preferably from 10 nm to 200 nm. The presence of the above-mentioned construction can provide a low refractive index layer having a sufficiently low refractive index and can maintain the transparency of the low refractive index layer. It should be noted that the term “average particle diameter” as used herein means a value determined by using a specific surface area (m²/g) measured by a nitrogen adsorption method (BET method) from an equation “average particle diameter=(2,720/specific surface area)” (see Japanese Patent Application Laid-open No. H1-317115).

Examples of a method of obtaining the low refractive index layer include methods described in Japanese Patent Application Laid-open No. 2010-189212, Japanese Patent Application Laid-open No. 2008-040171, Japanese Patent Application Laid-open No. 2006-011175, International Patent WO2004/113966A, and references thereof. Specific examples thereof include: a method involving subjecting at least one of silica-based compounds, and hydrolyzable silanes, and partial hydrolysates and dehydration condensates thereof to hydrolysis and polycondensation; a method involving using porous particles and/or hollow fine particles; and a method involving utilizing a spring-back phenomenon to produce an aerogel layer.

The low refractive index layer 20 is bonded to the polarizing plate 10 through any appropriate adhesion layer (such as an adhesive layer or a pressure-sensitive adhesive layer: not shown). In the case where the low refractive index layer is formed of a pressure-sensitive adhesive, the adhesion layer may be omitted. That is, in this case, the polarizing plate 10 and the prism sheet 30 are bonded to each other through a low refractive index pressure-sensitive adhesive.

D. Prism Sheet

The prism sheet 30 typically includes the base portion 31 and the prism portion 32. It should be noted that in this embodiment, the base portion 31 is not necessarily needed to be provided because the low refractive index layer 20 can function as a base portion for supporting the prism portion 32. When the optical member of the present invention is arranged on the backlight side of a liquid crystal display apparatus, the prism sheet 30 typically guides polarized light, which has been emitted from the light guide plate of the backlight unit of the apparatus, as polarized light having the maximum intensity in an approximately normal direction of the liquid crystal display apparatus to the polarizing plate 10 through the low refractive index layer 20 by means of, for example, total reflection in the prism portion 32 while maintaining the polarized state of the light. It should be noted that the term “approximately normal direction” comprehends a direction at a selected angle with respect to a normal direction, e.g., a direction at an angle in the range of ±10° with respect to the normal direction.

The prism sheet 30 is bonded to the low refractive index layer 20 through any appropriate adhesion layer (such as an adhesive layer or a pressure-sensitive adhesive layer: not shown). When the low refractive index layer is formed of the pressure-sensitive adhesive, the adhesion layer may be omitted.

D-1. Prism Portion

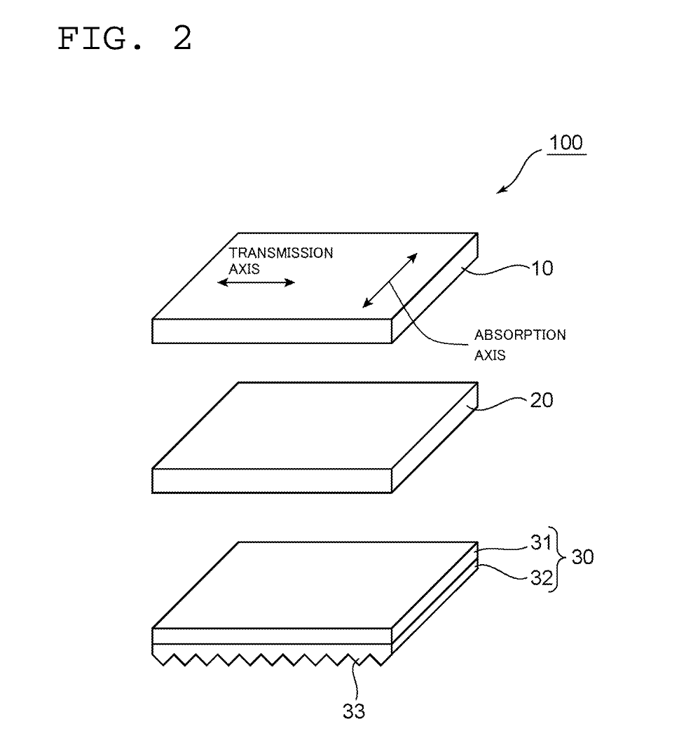

In one embodiment, as illustrated in each of FIGS. 1 and 2, the prism sheet 30 (substantially the prism portion 32) includes an array of a plurality of unit prisms 33, which are convex toward a side opposite to the low refractive index layer 20, in a parallel manner. Each of the unit prisms 33 is preferably columnar. The lengthwise direction (ridge line direction) of each of the unit prisms 33 is directed toward a direction approximately perpendicular or approximately parallel to the transmission axis of the polarizing plate 10. The lengthwise direction (ridge line direction) of each of the unit prisms 33 is preferably directed toward a direction approximately perpendicular to the transmission axis of the polarizing plate 10 as illustrated in FIG. 2. When the prism sheet and the polarizing plate are arranged so that the ridge line direction of each unit prism may be approximately perpendicular to the transmission axis of the polarizing plate, the brightness to be obtained in the liquid crystal display apparatus is additionally improved. In this specification, the expressions “substantially perpendicular” and “approximately perpendicular” include a case where an angle formed by two directions is 90°±10°, preferably 90°±7°, more preferably 90°±5°. The expressions “substantially parallel” and “approximately parallel” include a case where an angle formed by two directions is 0 °±10°, preferably 0°±7°, more preferably 0°±5° Moreover, in this specification, such a simple expression “perpendicular” or “parallel” can include a substantially perpendicular state or a substantially parallel state. It should be noted that the prism sheet 30 may be arranged so that the ridge line direction of each of the unit prisms 33, and the transmission axis of the polarizing plate 10 may form a selected angle (the so-called oblique arrangement). The adoption of such construction can prevent the occurrence of the moire in an additionally satisfactory manner in some cases. It should be noted that even when the oblique arrangement is intentionally performed, the angle is often at most about 10° and is hence included in the category “substantially parallel” in many cases.

Any appropriate construction can be adopted as the shape of each of the unit prisms 33 as long as the effects of the present invention are obtained. The shape of a section of each of the unit prisms 33 parallel to its arrangement direction and parallel to its thickness direction may be a triangular shape or may be any other shape (e.g., such a shape that one of, or each of both, the inclined planes of a triangle has a plurality of flat surfaces having different tilt angles). The triangular shape may be a shape asymmetric with respect to a straight line passing the apex of the unit prism and perpendicular to the surface of the sheet (e.g., a scalene triangle), or may be a shape symmetric with respect to the straight line (e.g., an isosceles triangle). Further, the apex of the unit prism may be of a chamfered curved surface shape, or may be of a shape whose section is a trapezoid, the shape being obtained by such cutting that its tip becomes a flat surface. Detailed shapes of the unit prisms 33 can be appropriately set depending on purposes. For example, a construction described in JP H11-84111 A can be adopted for each of the unit prisms 33.

D-2. Base Portion

When the prism sheet 30 is provided with the base portion 31, the base portion 31 and the prism portion 32 may be integrally formed by, for example, subjecting a single material to extrusion, or the prism portion may be shaped on a film for the base portion. The thickness of the base portion is preferably from 25 μm to 150 μm. With such thickness, the distance between the low refractive index layer and the prism portion can be caused to fall within the desired range. Further, such thickness is preferred from the viewpoints of the handling property and strength of the prism sheet.

Any appropriate material can be adopted as a material constituting the base portion 31 depending on purposes and the construction of the prism sheet. When the prism portion is shaped on the film for the base portion, the film for the base portion is specifically, for example, a film formed of cellulose triacetate (TAC), a (meth)acrylic resin such as polymethyl methacrylate (PMMA), or a polycarbonate (PC) resin. The film is preferably an unstretched film.

When the base portion 31 and the prism portion 32 are integrally formed of a single material, the same material as a material for forming the prism portion when the prism portion is shaped on the film for the base portion can be used as the material. Examples of the material for forming the prism portion include epoxy acrylate- and urethane acrylate-based reactive resins (such as an ionizing radiation-curable resin). When the prism sheet of an integral construction is formed, a polyester resin such as PC or PET, an acrylic resin such as PMMA or MS, or an optically transparent thermoplastic resin such as cyclic polyolefin can be used.

It is preferred that the base portion 31 substantially have optical isotropy. The phrase “substantially have optical isotropy” as used herein means that a retardation value is so small as to have substantially no influences on the optical characteristics of the liquid crystal display apparatus. For example, an in-plane retardation Re of the base portion is preferably 20 nm or less, more preferably 10 nm or less. It should be noted that the in-plane retardation Re is an in-plane retardation value measured at 23° C. with light having a wavelength of 590 nm. The in-plane retardation Re is represented by the equation “Re=(nx−ny)×t.” Here, nx represents a refractive index in the direction in which a refractive index becomes maximum in the plane of the optical member (i.e., a slow axis direction), ny represents a refractive index in a direction perpendicular to the slow axis in the plane (i.e., a fast axis direction), and t represents the thickness (nm) of the optical member.

Further, the photoelastic coefficient of the base portion 31 is preferably from −10×10⁻¹³ m²/N to 10×10⁻¹³ m²/N, more preferably from −5×10⁻¹³ m²/N to 5×10⁻¹³ m²/N, still more preferably from −3×10⁻¹³ m²/N to 3×10⁻¹³ m²/N.

E. Retardation Layer

The optical member 100 may further have any appropriate retardation layer at any appropriate position depending on purposes (not shown). The positions at which retardation layers are arranged, the number of the layers, the birefringence (refractive index ellipsoid) of each of the layers, and the like can be appropriately selected depending on, for example, the drive mode of a liquid crystal cell and desired characteristics. The retardation layer may also serve as a protective layer for a polarizer depending on purposes. Hereinafter, a typical example of the retardation layer applicable to the optical member of the present invention is described.

For example, in the case where the optical member is used in a liquid crystal display apparatus of an IPS mode, the optical member may include a first retardation layer, which satisfies a relationship of nx₁>ny₁>nz₁, on the side of the polarizing plate 10 opposite to the low refractive index layer 20. In this case, the optical member may further include a second retardation layer, which satisfies a relationship of nz₂>nx₂>ny₂, outside the first retardation layer (on a side opposite to the polarizing plate 10). The second retardation layer may be the so-called positive C-plate that satisfies a relationship of nz₂>nx₂=ny₂. The slow axis of the first retardation layer and the slow axis of the second retardation layer may be perpendicular or parallel to each other. The axes are preferably parallel to each other in consideration of the viewing angle and productivity of the optical member.

An in-plane retardation Re₁ of the first retardation layer is preferably from 60 nm to 140 nm. An Nz coefficient Nz₁ of the first retardation layer is preferably from 1.1 to 1.7. An in-plane retardation Reₑ of the second retardation layer is preferably from 10 nm to 70 nm. A thickness direction retardation Rth₂ of the second retardation layer is preferably from −120 nm to −40 nm. The in-plane retardations Re are as defined in the foregoing. The thickness direction retardation Rth is represented by the equation “Rth={(nx+ny)/2−nz}×d.” The Nz coefficient is represented by the equation “Nz=(nx−nz)/(nx−ny).” Here, nx and ny are as defined in the foregoing. nz represents a refractive index in the thickness direction of the optical member (here, the first retardation layer or the second retardation layer). It should be noted that the suffixes “1” and “2” represent the first retardation layer and the second retardation layer, respectively.

Alternatively, the first retardation layer may be a retardation layer that satisfies a relationship of nx₁>nz₁>ny₁. In this case, the second retardation layer is preferably the so-called negative C-plate that satisfies a relationship of nx₂=ny₂>nz₂. It should be noted that for example, the expression “nx=ny” as used herein comprehends not only the case where nx and ny are strictly equal to each other but also the case where nx and ny are substantially equal to each other. The purport of the phrase “substantially equal” as used herein is that the following case is also comprehended: the case where nx and ny are different from each other to the extent that the difference has no influences on the entire optical characteristics of the liquid crystal display apparatus in practical use. Therefore, the negative C-plate in this embodiment comprehends the case where the plate has biaxiality.

In addition, for example, in the case where the optical member is used in a liquid crystal display apparatus of a VA mode, the optical member may be used as a circularly polarizing plate. Specifically, the optical member may have the first retardation layer that functions as a λ/4 plate on the side of the polarizing plate 10 opposite to the light diffusion layer 20. In this case, an angle formed between the absorption axis of the polarizer and the slow axis of the first retardation layer is preferably substantially 45° or substantially 135°. Further, in this case, the liquid crystal display apparatus preferably includes a retardation layer that functions as a λ/4 plate between its liquid crystal cell and viewer side polarizing plate. The optical member may further have the second retardation layer, which satisfies a relationship of nz₂>nx₂>ny₂, between the polarizer and the first retardation layer. Further, when the retardation wavelength dispersion value (Re_{cell}[450]/Re_{cell} [550]) of the liquid crystal cell is represented by α_{cell} and the retardation wavelength dispersion value (Re₁[450]/Re₁[550]) of the first retardation layer is represented by α₁, the ratio/α₁/α_{cell} is preferably from 0.95 to 1.02. In addition, the Nz coefficient of the first retardation layer preferably satisfies a relationship of 1.1<Nz₁≦2.4, and the Nz coefficient of the second retardation layer preferably satisfies a relationship of −2≦Nz₂≦−0.1.

In addition, for example, in the case where the optical member is used in a liquid crystal display apparatus of a VA mode, the optical member may be used as a linearly polarizing plate. Specifically, the optical member may include the first retardation layer, which satisfies a relationship of nx₁>ny₁>nz₁, on the side of the polarizing plate 10 opposite to the low refractive index layer 20. The in-plane retardation Re₁ of the first retardation layer is preferably from 20 nm to 200 nm, more preferably from 30 nm to 150 nm, still more preferably from 40 nm to 100 nm. A thickness direction retardation Rth₁ of the first retardation layer is preferably from 100 nm to 800 nm, more preferably from 100 nm to 500 nm, still more preferably from 150 nm to 300 nm. The Nz coefficient of the first retardation layer is preferably from 1.3 to 8.0.

F. Polarizing Plate Set

The optical member of the present invention can be typically used as a polarizing plate arranged on the side of a liquid crystal display apparatus opposite to its viewer side (hereinafter sometimes referred to as “back surface side polarizing plate”). In this case, a polarizing plate set including the back surface side polarizing plate and a viewer side polarizing plate can be provided. Any appropriate polarizing plate can be adopted as the viewer side polarizing plate. The viewer side polarizing plate typically includes a polarizer (such as an absorption-type polarizer) and a protective layer arranged on at least one side of the polarizer. Those described in the section B can be used as the polarizer and the protective layer. The viewer side polarizing plate may further have any appropriate optical functional layer (such as a retardation layer, a hard coat layer, an antiglare layer, or an antireflection layer) depending on purposes. The polarizing plate set is arranged on each side of a liquid crystal cell so that the absorption axis of (the polarizer of) the viewer side polarizing plate and the absorption axis of (the polarizer of) the back surface side polarizing plate may be substantially perpendicular or parallel to each other.

G. Liquid Crystal Display Apparatus

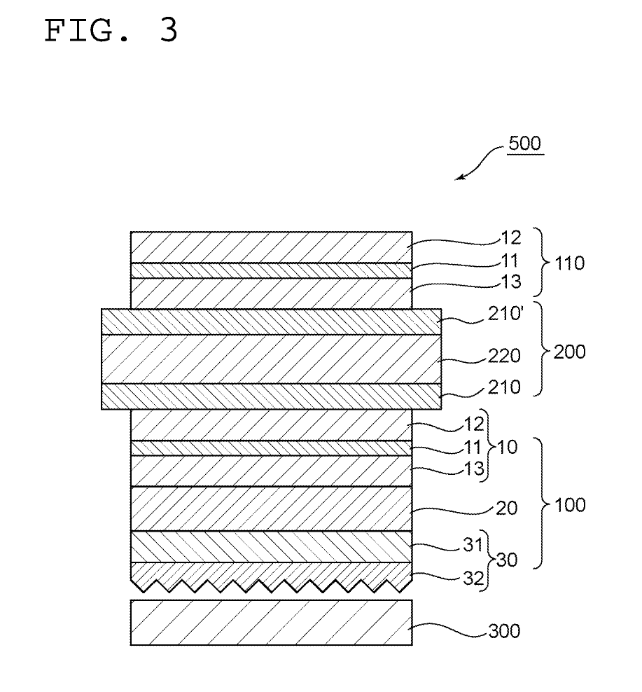

FIG. 3 is a schematic sectional view of a liquid crystal display apparatus according to one embodiment of the present invention. A liquid crystal display apparatus 500 includes a liquid crystal cell 200, a viewer side polarizing plate 110 arranged on the viewer side of the liquid crystal cell 200, the optical member 100 of the present invention as a back surface side polarizing plate arranged on the side of the liquid crystal cell 200 opposite to the viewer side, and a backlight unit 300 arranged on the side of the optical member 100 opposite to the liquid crystal cell 200. The optical member 100 is as described in the sections A to E. The viewer side polarizing plate is as described in the section F. In the illustrated example, the viewer side polarizing plate 110 includes the polarizer 11, the protective layer 12 arranged on one side of the polarizer, and the protective layer 13 arranged on the other side of the polarizer 11. The viewer side polarizing plate 110 and the optical member (back surface side polarizing plate) 100 are arranged so that their respective absorption axes may be substantially perpendicular or parallel to each other. Any appropriate construction can be adopted for the backlight unit 300. For example, the backlight unit 300 may be of an edge light system or may be of a direct system. When the direct system is adopted, the backlight unit 300 includes, for example, a light source, a reflective film, and a diffuser (none of which is shown). When the edge light system is adopted, the backlight unit 300 can further include a light guide plate and a light reflector (none of which is shown).

The liquid crystal cell 200 includes a pair of substrates 210 and 210′ and a liquid crystal layer 220 as a display medium sandwiched between the substrates. Ina general configuration, on the substrate 210′ as one in the pair, a color filter and a black matrix are provided, and on the substrate 210 as the other in pair, there are provided switching elements for controlling electro-optical property of the liquid crystal, scanning lines for giving gate signals to the switching elements and signal lines for giving source signals thereto, and pixel electrodes and counter electrodes. An interval (cell gap) between the above-mentioned substrates 210 and 210′ can be controlled by spacers and the like. On sides of the above-mentioned substrates 210 and 210′, which are brought into contact with the liquid crystal layer 220, for example, alignment films made of polyimide or the like can be provided.

In one embodiment, the liquid crystal layer 220 includes liquid crystal molecules aligned in a homogeneous alignment in a state where an electric field is not present. The liquid crystal layer (liquid crystal cell as a result) as described above typically exhibits a three-dimensional refractive index of nx>ny=nz. Note that, in this specification, ny=nz includes not only a case where ny and nz are completely the same, but also a case where ny and nz are substantially the same.

As a typical example of a drive mode using the liquid crystal layer that exhibits the three-dimensional refractive index as described above, the in-plane switching (IPS) mode, the fringe field switching (FFS) mode, and the like are given. In the above-mentioned IPS mode, by using the electrically controlled birefringence (ECB) effect, the liquid crystal molecules aligned in the homogeneous alignment in the state where an electric field is not present are allowed to respond, for example, to an electric field (also referred to as a horizontal electric field), which is generated by the counter electrode and pixel electrode, each being formed of metal, and is parallel to the substrates. More specifically, for example, as described in “Monthly Display, July” pp. 83 to 88 (1997), published by Techno Times Co., Ltd. and “Ekisho vol. 2, No. 4” pp. 303 to 316 (1998), published by The Japanese Liquid Crystal Society, when an alignment direction of the liquid crystal cell at the time when no electric field is applied thereto and an absorption axis of a polarizer on one side are allowed to coincide with each other, and the upper and lower polarizing plates are arranged perpendicularly to each other, the normally black mode provides completely black display in the state where no electric field is present. When the electric field is present, the liquid crystal molecules perform a rotation operation while remaining parallel to the substrates so that a transmittance corresponding to a rotation angle can be obtained. Note that, the above-mentioned IPS mode includes the super in-plane switching (S-IPS) mode and the advanced super in-plane switching (AS-IPS) mode, each of which employs a V-shaped electrode, a zigzag electrode, or the like.

In the above-mentioned FFS mode, by using the electrically controlled birefringence effect, the liquid crystal molecules aligned in the homogeneous alignment in the state where no electric field is present are allowed to respond, for example, to an electric field (also referred to as a horizontal electric field), which is generated by the counter electrode and pixel electrode, each being formed of a transparent conductor, and is parallel to the substrates. Note that, the horizontal electric field in the FFS mode is also referred to as a fringe electric field. This fringe electric field can be generated by setting an interval between the counter electrode and the pixel electrode, each of which is formed of the transparent conductor, narrower than the cell gap. More specifically, for example, as described in “SID (Society for Information Display) 2001 Digest, pp. 484 to 487” and JP 2002-031812 A, when an alignment direction of the liquid crystal cell at the time when no electric field is applied thereto and an absorption axis of a polarizer on one side are allowed to coincide with each other, and the upper and lower polarizing plates are arranged perpendicularly to each other, the normally black mode provides completely black display in the state where no electric field is present. When the electric field is present, the liquid crystal molecules perform a rotation operation while remaining parallel to the substrates so that a transmittance corresponding to a rotation angle can be obtained. Note that, the above-mentioned FFS mode includes the advanced fringe field switching (A-FFS) mode and the ultra fringe field switching (U-FFS) mode, each of which employs a V-shaped electrode, a zigzag electrode, or the like.

In the drive mode (for example, the IPS mode, the FFS mode) using the liquid crystal molecules aligned in the homogeneous alignment in the state where no electric field is present, there is no oblique gray-scale inversion, and an oblique viewing angle thereof is wide, and accordingly, there is an advantage in that visibility in an oblique direction is excellent even when the surface light source directed in the front direction, which is used in the present invention, is used.

In another embodiment, the liquid crystal layer 220 includes liquid crystal molecules aligned in a homeotropic alignment in the state where no electric field is present. The liquid crystal layer (liquid crystal cell as a result) as described above typically exhibits a three-dimensional refractive index of nz>nx=ny. As a drive mode using the liquid crystal molecules aligned in the homeotropic alignment in the state where no electric field is present, for example, the vertical alignment (VA) mode is given. The VA mode includes the multi-domain VA (MVA) mode.

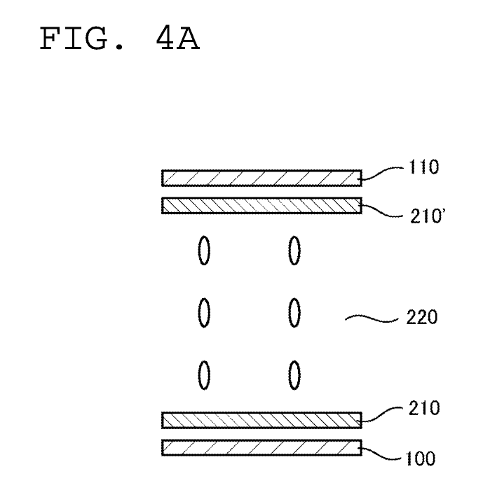

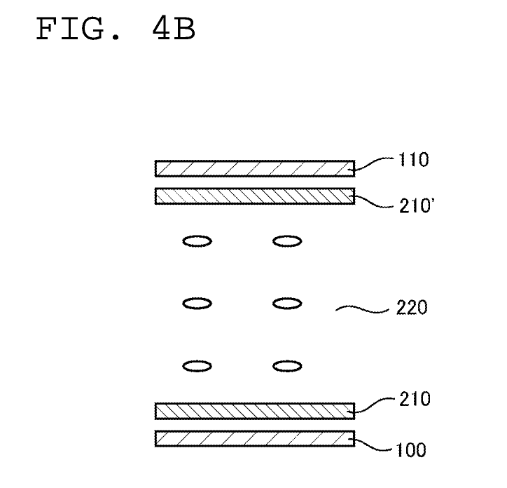

FIGS. 4A and 4B are schematic sectional views illustrating aligned states of the liquid crystal molecules in the VA mode. As illustrated in FIG. 4A, the liquid crystal molecules in the VA mode are aligned, at the time when no voltage is applied thereto, approximately vertically (normal direction) on the substrates 210 and 210′. Here, the term “approximately vertical” also includes a case where an alignment vector of the liquid crystal molecules is inclined with respect to the normal direction, that is, a case where the liquid crystal molecules have a tilt angle. The tilt angle (angle from the normal line) is preferably 10° or less, more preferably 5° or less, particularly preferably 1° or less. The liquid crystal molecules have the tilt angle in such a range so that the liquid crystal display apparatus can be excellent in contrast. Moreover, moving picture display characteristics can be enhanced. The approximately vertical alignment as described above can be realized, for example, by arranging nematic liquid crystal, which has negative dielectric anisotropy, between substrates on which vertical alignment films are formed. In such a state, light of linearly polarized light, which passes through the optical member 100 and enters the liquid crystal layer 220, travels along a direction of a major axis of the liquid crystal molecules aligned approximately vertically. The birefringence is not generated substantially in a major axis direction of the liquid crystal molecules, and accordingly, the incident light travels without changing a polarization direction thereof, and is absorbed by the viewer side polarizing plate 110 having a transmission axis perpendicular to the optical member 100. In this manner, display of a dark state is obtained at the time when no voltage is applied (normally black mode). As illustrated in FIG. 4B, when a voltage is applied between the electrodes, the major axis of the liquid crystal molecules is aligned parallel to the substrate surfaces. The liquid crystal molecules in this state exhibit the birefringence to the light of the linearly polarized light, which passes through the optical member 100 and enters the liquid crystal layer, and the polarization state of the incident light is changed in response to an inclination of the liquid crystal molecules. The light that passes through the liquid crystal layer 220 at a time when a selected maximum voltage is applied becomes, for example, linearly polarized light in which a polarization direction is rotated by 90°, and accordingly, the light transmits through the viewer side polarizing plate 110, and display of a bright state is obtained. When the state where no voltage is applied is set again, the display can be returned to the display of the dark state by alignment regulating force. Moreover, the inclination of the liquid crystal molecules is controlled by changing the applied voltage, and transmission intensity of the light from the viewer side polarizing plate 110 is changed so that gray-scale display becomes possible.

### EXAMPLES

The present invention is specifically described below by way of examples, but the present invention is not limited to these examples. Testing and evaluating methods in the examples are as follows. Moreover, unless particularly specified, “parts” and “%” in the examples are weight-based units.

### (1) Method of Measuring Refractive Index and Thickness

A refractive index and a thickness were determined by performing reflection measurement with an ellipsometer (product name: “Woollam M2000”, manufactured by J. A. Woollam).

(2) Evaluation of Total Thickness from Prism Sheet to Lower Polarizing Plate

The case where the total thickness of the resultant liquid crystal display apparatus from its prism sheet to its lower polarizing plate was 500 μm or less was evaluated as ∘, and the case where the total thickness exceeded 500 μm was evaluated as x.

### (3) Front Brightness of Liquid Crystal Display Apparatus

The liquid crystal display apparatus was caused to perform white display on its entire screen and measured for its front brightness (unit: cd/m²) with a conoscope (manufactured by AUTRONIC MELCHERS).

### (4) Diffusion Illuminance of Liquid Crystal Display Apparatus

A light diffusion illuminance (unit: Lx) was calculated by: arranging conoscopes (manufactured by AUTRONIC MELCHERS) above the liquid crystal display apparatus at a selected interval; and measuring brightnesses L in all azimuth angle directions every 1°.

### Example 1

### Production of Film for First Retardation Layer

A commercially available polymer film [manufactured by Optes Inc., trade name: “ZeonorFilm ZF14-130 (thickness: 60 μm, glass transition temperature: 136° C.)”] whose main component was a cyclic polyolefin-based polymer was subjected to fixed-end uniaxial stretching in its width direction with a tenter stretching machine at a temperature of 158° C. in such a manner that its film width was 3.0 times as large as the original film width (lateral stretching step). The resultant film was a negative biaxial plate (three-dimensional refractive index: nx>ny>nz) having a fast axis in the conveying direction. The negative biaxial plate had an in-plane retardation of 118 nm and an Nz coefficient of 1.16.

(Production of Film for Second Retardation Layer)

A pellet-shaped resin of a styrene-maleic anhydride copolymer (manufactured by Nova Chemicals Japan Ltd., product name: “DYLARK D232”) was extruded with a single screw extruder and a T die at 270° C., and the resultant sheet-shaped molten resin was cooled with a cooling drum to obtain a film having a thickness of 100 μm. The film was subjected to free-end uniaxial stretching in the conveying direction with a roll stretching machine at a temperature of 130° C. and a stretching ratio of 1.5 times to obtain a retardation film having a fast axis in the conveying direction (longitudinal stretching step). The resultant film was subjected to fixed-end uniaxial stretching in its width direction with a tenter stretching machine at a temperature of 135° C. in such a manner that its film width was 1.2 times as large as the film width after the longitudinal stretching, thereby obtaining a biaxially stretched film having a thickness of 50 μm (lateral stretching step). The resultant film was a positive biaxial plate (three-dimensional refractive index: nz>nx>ny) having a fast axis in the conveying direction. The positive biaxial plate had an in-plane retardation of 20 nm and a thickness direction retardation Rth of −80 nm.

(Production of Polarizing Plate with Retardation Layers)

A polymer film containing polyvinyl alcohol as a main component [manufactured by KURARAY CO., LTD., trade name “9P75R (thickness: 75 μm, average polymerization degree: 2,400, saponification degree: 99.9 mol %)”] was stretched in its conveying direction at a ratio of 1.2 times while being immersed in a water bath for 1 minute. After that, the film was stretched at a ratio of 3 times with reference to a film (original length), which had not been stretched at all, in the conveying direction while being dyed by being immersed in an aqueous solution having an iodine concentration of 0.3 wt % for 1 minute. Next, the stretched film was further stretched at a ratio of up to 6 times with reference to the original length in the conveying direction while being immersed in an aqueous solution having a boric acid concentration of 4 wt % and a potassium iodide concentration of 5 wt %. The resultant was dried at 70° C. for 2 minutes to obtain a polarizer.

Meanwhile, an alumina colloid-containing adhesive was applied to one surface of a triacetylcellulose (TAC) film (manufactured by KONICA MINOLTA, INC., product name “KC4UYW,” thickness: 40 μm), and the resultant was laminated on one surface of the polarizer obtained in the foregoing by a roll-to-roll process so that the conveying directions of both the polarizer and the film were parallel to each other. It should be noted that the alumina colloid-containing adhesive was prepared by: dissolving 50 parts by weight of methylol melamine with respect to 100 parts by weight of a polyvinyl alcohol-based resin having an acetoacetyl group (average polymerization degree: 1,200, saponification degree: 98.5 mol %, acetoacetylation degree: 5 mol %) in pure water to prepare an aqueous solution having a solid content of 3.7 wt %; and adding 18 parts by weight of an aqueous solution containing an alumina colloid having a positive charge (average particle diameter: 15 nm) at a solid content of 10 wt % to 100 parts by weight of the resultant aqueous solution. Subsequently, a film for a first retardation layer having applied thereto the alumina colloid-containing adhesive was laminated on a surface of the polarizer opposite to the TAC film by the roll-to-roll process so that their conveying directions were parallel to each other. After that, the laminate was dried at 55° C. for 6 minutes. A film for a second retardation layer was laminated on the surface of the first retardation layer of the laminate after the drying through an acrylic pressure-sensitive adhesive (thickness: 5 μm) by the roll-to-roll process so that their conveying directions were parallel to each other. Thus, a polarizing plate with retardation layers (second retardation layer/first retardation layer/polarizer/TAC film) was obtained.

(Prism Sheet)

A commercial notebook personal computer (manufactured by Sony Corporation, trade name: “VAIO Type S”) was dismantled, a prism sheet on its backlight side was removed, and a diffusion layer present on a surface on a side opposite to its prism portion was removed with ethyl acetate. Thus, a prism sheet free of any diffusion layer was prepared as a prism sheet of this example.

(Low Refractive Index Layer)

A layer obtained as follows was used as a low refractive index layer: the surface of the prism sheet on the side opposite to the prism portion was coated with an application liquid prepared by dispersing spherical hollow silica particles having an average particle diameter of around 40 nm in methyl isobutyl ketone (MIBK) as a solvent (manufactured by JGC Catalysts and Chemicals Ltd., trade name: “THRULYA 4320”); and the liquid was dried at 80° C. for 1 minute. The layer was evaluated for its thickness and refractive index. As a result, the thickness was 400 nm and the refractive index was 1.19.

(Production of Optical Member)

The polarizing plate with the retardation layers obtained in the foregoing and the laminate having a construction “low refractive index layer/prism sheet” obtained in the foregoing were bonded to each other through an acrylic pressure-sensitive adhesive. As a result, such an optical member having a construction “polarizing plate/low refractive index layer/prism sheet” as illustrated in FIG. 1 was obtained. It should be noted that the polarizing plate and the laminate were integrated so that the ridge line direction of each unit prism of the prism sheet and the transmission axis of the polarizing plate were parallel to each other. Therefore, the integration was performed so that the ridge line direction of each unit prism of the prism sheet and the absorption axis of the polarizing plate were perpendicular to each other. The thickness of the low refractive index layer in the optical member having such arrangement relationship was 400 nm.

(Production of Liquid Crystal Display Apparatus Using Optical Member of the Present Invention)

A liquid crystal display panel was taken out of a liquid crystal display apparatus of the IPS mode (manufactured by Apple Inc., trade name: “iPad2”), and an optical member such as a polarizing plate was removed from the liquid crystal display panel to take out a liquid crystal cell. Both surfaces (outside of each glass substrate) of the liquid crystal cell were cleaned for use. A commercially available polarizing plate (manufactured by Nitto Denko Corporation, product name: “CVT1764FCUHC”) was attached onto the upper side of the liquid crystal cell (viewer side). Further, in order to improve visibility in viewing the liquid crystal display apparatus while wearing polarizing sunglasses, a λ/4 plate (manufactured by Kaneka Corporation, trade name: “UTZ film #140”) was attached onto the polarizing plate in such a manner that its slow axis formed an angle of 45° with respect to the absorption axis of the polarizing plate. Further, the optical member obtained in the foregoing was attached as a lower side (back surface side) polarizing plate to the lower side (back surface side) of the liquid crystal cell through an acrylic pressure-sensitive adhesive. Thus, a liquid crystal display panel was obtained. At this time, the attachment was performed so that the transmission axes of the respective polarizing plates were perpendicular to each other.

Meanwhile, a backlight unit removed from the commercial notebook personal computer (manufactured by Sony Corporation, trade name: “VAIO Type S”) was used as a backlight unit. The backlight unit was incorporated into the liquid crystal display panel obtained in the foregoing to produce such a liquid crystal display apparatus as illustrated in FIG. 3.

### Example 2

A liquid crystal display apparatus using the optical member of the present invention was produced in the same manner as in Example 1 except that the optical member was produced so that the thickness of the low refractive index layer became 800 nm.

### Example 3

A liquid crystal display apparatus using an optical member was produced in the same manner as in Example 1 except that a low refractive index layer was obtained as described below. That is, an aerogel layer was produced on the surface of the prism sheet on the side opposite to the prism portion by utilizing a spring-back phenomenon, and the layer was used as the low refractive index layer. The aerogel layer was produced in accordance with the procedure described in Example 1 of Japanese Patent Application Laid-open No. 2006-011175.

### Example 4

A liquid crystal display apparatus using an optical member was produced in the same manner as in Example 1 except that a low refractive index layer was obtained as described below. That is, a porous layer obtained by coating the surface of the prism sheet on the side opposite to the prism portion with a material having dispersed therein needle-like silica particles instead of the hollow silica particles used in Example 1 was used as the low refractive index layer.

### Example 5

An optical member was obtained in the same manner as in Example 1 except that a low refractive index layer was obtained as described below. A liquid crystal display apparatus was produced by using the optical member. That is, the low refractive index layer was formed on the surface of the prism sheet on the side opposite to the prism portion as described below. 0.5 Gram of a 0.01 mol/L aqueous solution of oxalic acid was added to a mixed liquid obtained by dissolving 0.95 g of methyltrimethoxysilane (MTMS) as a precursor of a silicon compound in 2.2 g of dimethyl sulfoxide (DMSO), and the mixture was stirred at room temperature for 30 minutes to hydrolyze MTMS. Thus, tris(hydroxy)methylsilane was produced. After that, 0.38 g of ammonia water having a concentration of 28% and 0.2 g of pure water were added to 5.5 g of DMSO. After that, the mixed liquid subjected to the hydrolysis treatment was further added to the mixture and the whole was stirred at room temperature for 15 minutes to cause tris(hydroxy)methylsilane to gel. Thus, a gel silicon compound was obtained. The mixed liquid subjected to the gelation treatment was subjected to aging treatment by being incubated as it was at 40° C. for 20 hours. Next, the gel silicon compound subjected to the aging treatment was pulverized with a spatula into granules each having a size of from several millimeters to several centimeters. 40 Grams of isopropyl alcohol (IPA) were added to the granules and the mixture was lightly stirred. After that, the solvent and catalyst in the gel were decanted by leaving the mixture at rest at room temperature for 6 hours. The same decantation treatment was repeated three times to complete solvent substitution. Then, the gel silicon compound in the mixed liquid was subjected to pulverization treatment. In the pulverization treatment, 1.18 g of the gel and 1.14 g of IPA were weighed in a 5-cm³ screw bottle, and then the mixture was pulverized with a homogenizer (trade name: “UH-50”, manufactured by SMT Corporation) for 2 minutes under the conditions of 50 W and 20 kHz. The gel silicon compound in the mixed liquid was pulverized by the pulverization treatment, and as a result, the mixed liquid turned into a sol liquid of a pulverized product. A volume-average particle diameter representing the particle size variation of the pulverized product in the mixed liquid was confirmed. As a result, the volume-average particle diameter was from 0.5 μm to 0.7 μm. Further, a 0.3 wt % aqueous solution of KOH was prepared and 0.02 g of KOH was added to 0.5 g of the sol liquid to prepare an application liquid. A layer obtained by coating the surface of the prism sheet on the side opposite to the prism portion with the application liquid and drying the liquid at 80° C. for 1 minute was used as the low refractive index layer. The layer was evaluated for its thickness and refractive index. As a result, the thickness was 1,000 nm and the refractive index was 1.07.

### Comparative Example 1

A liquid crystal display apparatus using an optical member was produced in the same manner as in Example 1 except that the polarizing plate with the retardation layers and the reverse prism sheet were bonded to each other through an acrylic pressure-sensitive adhesive.

### Comparative Example 2

A liquid crystal display apparatus using an optical member was produced in the same manner as in Example 1 except that a fluorine-mixed acrylic hard coat as a low refractive index coating agent (manufactured by DAIKIN INDUSTRIES, LTD., trade name: “AR110”) was applied to a space between the polarizing plate with the retardation layers and the reverse prism sheet, and was dried at 80° C. for 1 minute, and then the dried product was irradiated with UV light having an energy of 300 mJ to provide a low refractive index layer.

### Comparative Example 3

A liquid crystal display apparatus using an optical member was produced in the same manner as in Example 1 except that a low refractive index layer was obtained as described below. That is, a coating film was produced by: applying, to the surface of the prism sheet on the side opposite to the prism portion, a mixed liquid obtained by adding, to 25 g of pentaerythritol triacrylate (manufactured by Osaka Organic Chemical Industry Ltd., trade name: “VISCOAT #300”, refractive index: 1.52), 375 g of an application liquid (trade name: “THRULYA 4320”) and 5 g of a photopolymerization initiator (manufactured by BASF, trade name: “IRGACURE 907”); drying the liquid at 80° C. for 1 minute; and then irradiating the dried product with UV light having an energy of 300 mJ. The coating film had a refractive index of 1.34 and a thickness of 1,000 nm.

### Comparative Example 4

A liquid crystal display apparatus in which a prism sheet was arranged as a separate body was produced in the same manner as in Example 1 except that the reverse prism sheet was incorporated into the backlight unit and the resultant was provided as a member separate from the polarizing plate with the retardation layers.

The liquid crystal display apparatus obtained in each of Examples and Comparative Examples was subjected to the evaluations (1) to (4). Table 1 and Table 2 show the results. It should be noted that a front brightness ratio and diffusion illuminance ratio in Table 2 represent ratios in the case where the front brightness and diffusion illuminance of Comparative Example 1 are defined as 100%, respectively.

TABLE 1

| | | Low refractive index layer | | Total thickness from |
|---|---|---|---|---|
| | | Refractive | Thickness | prism sheet to lower |
| | | index | (nm) | polarizing plate |
| Example | 1 | 1.19 | 400 | ∘ |
| | 2 | 1.19 | 800 | ∘ |
| | 3 | 1.10 | 300 | ∘ |
| | 4 | 1.24 | 900 | ∘ |
| | 5 | 1.07 | 1,000 | ∘ |
| Comparative | 1 | 1.47 | — | ∘ |
| Example | 2 | 1.38 | 1,000 | ∘ |
| | 3 | 1.34 | 1,000 | ∘ |
| | 4 | 1.00 | — | x |

TABLE 2

| | | | Front | | Diffusion |
|---|---|---|---|---|---|
| | | Front | brightness | Diffusion | illuminance |
| | | brightness | ratio | illuminance | ratio |
| Example | 1 | 599 | 108% | 220 | 113% |
| | 2 | 613 | 110% | 230 | 118% |
| | 3 | 608 | 109% | 226 | 116% |
| | 4 | 597 | 107% | 225 | 115% |
| | 5 | 610 | 110% | 232 | 119% |
| Comparative | 1 | 556 | 100% | 195 | 100% |
| Example | 2 | 576 | 104% | 197 | 101% |
| | 3 | 588 | 106% | 200 | 103% |
| | 4 | 532 | 96% | 223 | 114% |

As is apparent from Table 1 and Table 2, in liquid crystal display apparatus each using an optical member obtained by integrating a polarizing plate and a prism sheet as a back surface-side polarizing plate, a liquid crystal display apparatus using the optical member of any one of Examples of the present invention as a back surface-side polarizing plate can attain higher brightness as compared with the case of using a related-art optical member. Further, the liquid crystal display apparatus using the optical member of any one of Examples of the present invention as a back surface-side polarizing plate is excellent in mechanical strength because a light guide plate is not flawed by rubbing between the prism sheet and the light guide plate unlike the case where the polarizing plate and the prism sheet are used while being separately arranged. Further, the total thickness of the liquid crystal display apparatus can be reduced.

The optical member of the present invention can be suitably used as a back surface side polarizing plate for a liquid crystal display apparatus. The liquid crystal display apparatus using such optical member can be used for various applications such as portable devices including a personal digital assistant (PDA), a cellular phone, a watch, a digital camera, and a portable gaming machine, OA devices including a personal computer monitor, a notebook-type personal computer, and a copying machine, electric home appliances including a video camera, a liquid crystal television set, and a microwave oven, on-board devices including a reverse monitor, a monitor for a car navigation system, and a car audio, exhibition devices including an information monitor for a commercial store, security devices including a surveillance monitor, and caring/medical devices including a caring monitor and a medical monitor.

The optical member of the present invention includes the polarizing plate, the low refractive index layer having a selected refractive index, and the prism sheet, and hence can realize a liquid crystal display apparatus that provides sufficient brightness. Further, the polarizing plate and the prism sheet are integrated, and hence the optical member of the present invention can realize a liquid crystal display apparatus excellent in mechanical strength.

Many other modifications will be apparent to and be readily practiced by those skilled in the art without departing from the scope and spirit of the invention. It should therefore be understood that the scope of the appended claims is not intended to be limited by the details of the description but should rather be broadly construed.

What is claimed is:

1. An optical member, comprising:
a polarizing plate;
a low refractive index layer; and
a prism sheet,
wherein a refractive index n of the low refractive index layer satisfies a relationship of 1<n≦1.25.

2. The optical member according to claim 1, wherein the refractive index n of the low refractive index layer and a thickness d (nm) thereof satisfy a relationship represented by one of the following formulae (1) and (2).
1<n≦1.20 and 300≦d (1)
1.20<n≦1.25 and 500≦d (2)

3. The optical member according to claim 1, wherein the prism sheet comprises an array of a plurality of columnar unit prisms that are convex toward a side opposite to the low refractive index layer.

4. The optical member according to claim 1, wherein the polarizing plate and the low refractive index layer are directly laminated through a pressure-sensitive adhesive.

5. The optical member according to claim 1, wherein the optical member comprises the polarizing plate, the low refractive index layer, and the prism sheet in the stated order.

6. A polarizing plate set, comprising:
the optical member according to claim 1 to be used as a back surface-side polarizing plate; and
a viewer-side polarizing plate.

7. A liquid crystal display apparatus, comprising:
a liquid crystal cell;
a polarizing plate arranged on a viewer side of the liquid crystal cell; and
the optical member according to claim 1 arranged on a side of the liquid crystal cell opposite to the viewer side.
